(19) United States
(12) Patent Application Publication
(10) Pub. No.: US 2025/0393032 A1
(43) Pub. Date: Dec. 25, 2025

(54) UE-TRIGGERED SLOT AGGREGATION ACTIVATION

(71) Applicant: T-Mobile USA, Inc., Bellevue, WA (US)

(72) Inventor: Christopher Bailey, Overland Park, KS (US)

(21) Appl. No.: 18/750,383

(22) Filed: Jun. 21, 2024

(51) Int. Cl. H04W 72/0446; H04L 1/08

(52) U.S. Cl. CPC H04W 72/0446; H04L 1/08

(57) ABSTRACT

Described herein are a user equipment (UE) and base station configured to activate slot aggregation for the UE. The UE is configured to determine that one or more performance indicators of uplink quality meet an activation threshold for slot aggregation and, in response, to transmit a packet repeatedly to the base station in consecutive slots. The base station can also be configured to determine that one or more performance indicators of uplink quality from the UE meet an activation threshold for slot aggregation. In response, the base station may schedule consecutive slots for transmission of a packet from the UE to the base station.

### BACKGROUND

Poor uplink quality between a user equipment (UE) and a base station often results in dropped, delayed, or out-of-order packets. One solution, slot aggregation, improves data packet transmission by repeatedly sending the data packet in consecutive slots. Slot aggregation is triggered by the base station, such as a gNode B (gNB) in criteria that are rarely met before a handover is triggered. The UE is then handed over to a different radio band and may face similar challenges with that band.

### BRIEF DESCRIPTION OF THE DRAWINGS

The detailed description is set forth with reference to the accompanying figures. In the figures, the left-most digit(s) of a reference number identifies the figure in which the reference number first appears. The same reference numbers in different figures indicate similar or identical items.

FIG. 1 is an overview diagram of scenarios utilizing slot aggregation in response to UE determinations or base station scheduling.

FIG. 2 is a flow diagram of an illustrative process implemented by a UE for determining that performance indicator(s) of uplink quality meet an activation threshold for slot aggregation and, in response, transmitting a packet repeatedly to a base station in consecutive slots.

FIG. 3 is a flow diagram of an illustrative process implemented by a base station for determining that performance indicator(s) of uplink quality from a UE meet an activation threshold for slot aggregation and, in response, scheduling consecutive slots for transmission of a packet from the UE to the base station.

FIG. 4 is a schematic diagram of a computing device capable of implementing functionality of at least one of the UE or base station described herein.

### DETAILED DESCRIPTION

This disclosure is directed in part to determining that one or more performance indicators of uplink quality meet an activation threshold for slot aggregation. This determination may be made by the UE for itself or may be made by the base station for the user equipment (UE). When a base station determines that the activation threshold has been met, the base station schedules consecutive slots for transmission of a packet from the UE to the base station and may provide an indication of the scheduled consecutive slots to the UE. In other implementations where the base station does not determine that the activation threshold has been met, it may support slot aggregation by making pre-scheduled grants or configured grants for use by the UE or by responding to UE scheduling requests for slot aggregation. One or more performance indicators used by the UE may include at least one of jitter, a mean opinion score (MOS), a number of negative acknowledgements (NACKs) received, block error rate (BLER), packet delay, muting, or round-trip times. Performance indicators referenced by the base station may include one or more performance indicators include at least one of uplink signal-to-noise-ratio (SINR) or power headroom.

When the UE determines that the activation threshold has been met, the UE transmits a packet repeatedly to a base station in consecutive slots. As noted, it may do so in pre-scheduled or configured grants or may request slot aggregation. The UE may continue to use slot aggregation for transmitting uplink packets until a deactivation threshold is met. The performance indicators used to evaluate whether the deactivation threshold is met may be the same types of performance indicators used for the activation threshold, may overlap with those performance indicators, or may be different from them.

In some implementations, determining that one or more performance indicators of uplink quality meet the activation threshold may further be based on a location of the UE within a cell associated with the base station. For example, the activation threshold used may vary based on the location, with an activation threshold at a cell edge being more easily met than an activation threshold at cell center.

In further or additional implementations, the one or more performance indicators may include at least one of a reference signal received power (RSRP) or a noise reference signal received quality (RSRQ) and the activation threshold may be reached before a handover threshold for handing over a connection between the UE and the base station from a first band to a second band. Also, in some examples, the activation threshold may vary based on the band that the UE is connected to.

In various implementations, once the slot aggregation has been activated, the UE may transmit packets to the base station using slot aggregation, and the base station may retransmit only one copy of each packet (e.g., based on cyclic redundancy checks).

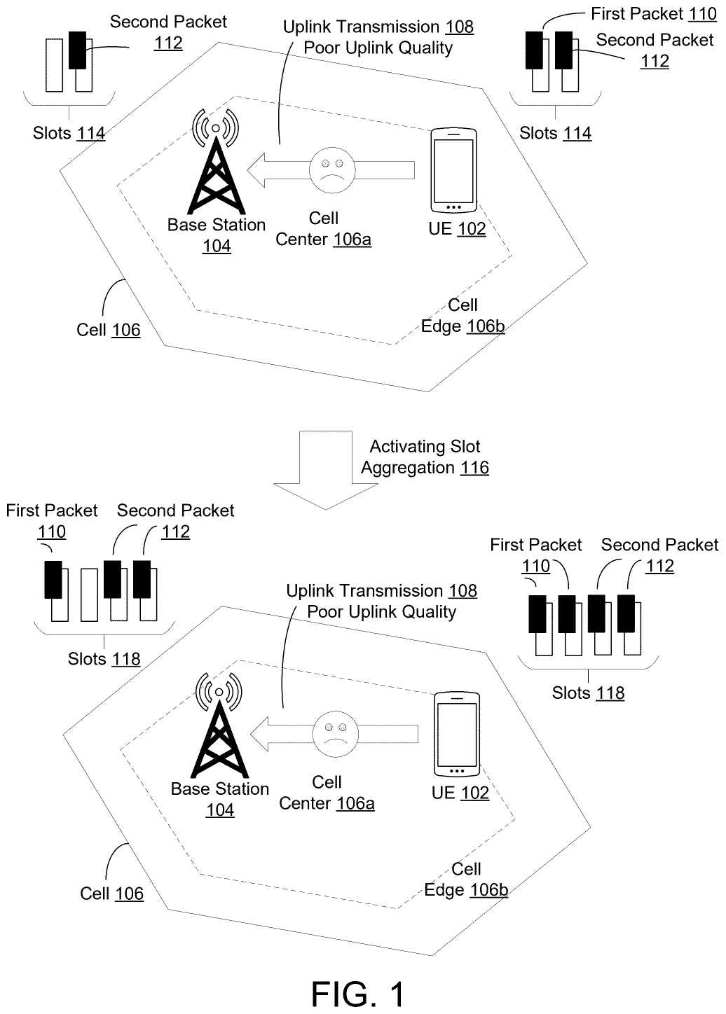

FIG. 1 is an overview diagram of scenarios utilizing slot aggregation in response to UE determinations or base station scheduling. As illustrated, a UE 102 may be connected to a base station 104 of telecommunications network cell 106 (“cell 106”). The cell 106 may include an area closer to the base station 104 referred to as the “cell center” 106a and an area furthest from the base station 104 but still within the cell 106, referred to as the “cell edge” 106b. The UE 102 may engage in an uplink transmission 108 to base station 104. As shown in FIG. 1, the uplink transmission 108 may have poor uplink quality. FIG. 1 also slows the transmission of a first packet 110 and a second packet 112 in slots 114. In the upper half of FIG. 1, the first packet 110 and a second packet 112 are not shown as repeating, and one or both of the first packet 110 and a second packet 112 may be a dropped packet not received by the base station 104 or received only partially. Following activation of slot aggregation, shown as arrow 116, the UE 102 may repeat the transmission of the first packet 110 and of the second packet 112 in consecutive slots 118, increasing the number of slots used but substantially increasing the chance of the received uplink data being of the same quality as the data being sent as first packet 110 and a second packet 112. Thus, the base station 104 at the lower left of FIG. 1 is shown receiving at least one complete copy of each of first packet 110 and a second packet 112.

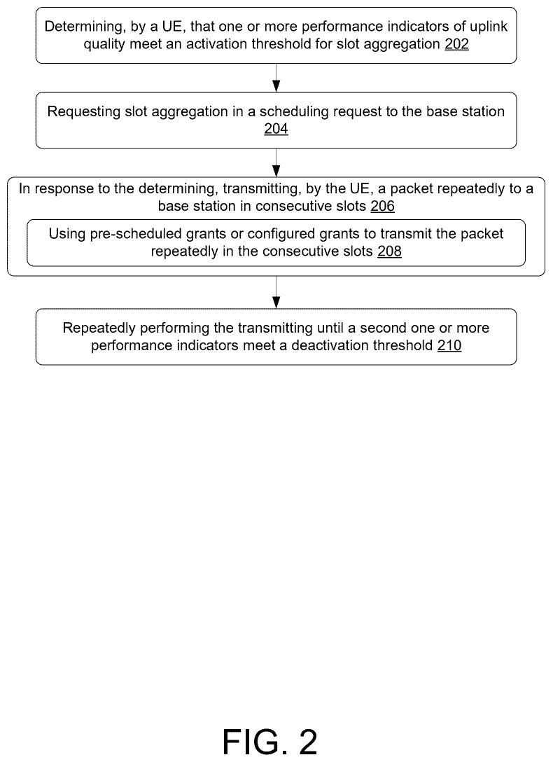

In various implementations, the UE 102 may be any sort of mobile telecommunications device. UE 102 may be a cellular phone, a tablet computer, a watch, goggles, an Internet-of-Things (IoT) device, a personal computer (PC), a gaming device, or any sort of device capable of wireless and/or cellular communication with telecommunications network. The UE 102 is also described in greater detail herein with respect to FIGS. 2-4.

Base station 104 may be any kind of cellular base station, wireless access point, satellite, or other mechanism providing cellular and/or wireless communication capabilities. Base station 104 may operate in accordance with Third Generation Partnership Protocol (3GPP) standards and may implement sixth generation (6G) technology, fifth generation (5G) technology, fourth generation (4G) technology, third generation (3G) technology, or any earlier or later generation of technology. For example, the base station 104 may implement 5G technology and be a gNodeB (gNB). Further, the base station 104 may include one or more radio antennas, wireless transceivers, etc., for sending downlink transmissions and receiving uplink transmissions, such as uplink transmission 108.

In some implementations, without slot aggregation, the UE 102 transmits uplink packets (e.g., first packet 110 and second packet 112) without repetition, or at least without the organized, more systematic repetition that occurs with slot aggregation. With poor uplink quality for the uplink transmission 108, such as bad jitter, a low MOS, a high number of NACKs received, etc., one or both of the first packet 110 and second packet 112 may not be received, resulting in packet loss. These poor performance metrics for uplink quality may result in a handover—e.g., from one band of base station 104 to another band of base station 104, but the resulting band may also be experiencing uplink quality issues. Even if slot aggregation is available based on base station 104 determining uplink quality, activation thresholds may never be reached because handover thresholds may be lower.

As shown in FIG. 1 with arrow 116 and the activation of slot aggregation that it signifies, results of slot aggregation-shown in the bottom half of FIG. 1—may be different and better than those shown in the upper half of that figure.

Slot aggregation can be triggered based on thresholds and performance metrics. For example, an activation threshold or thresholds can be measured against one or more performance indicators of uplink quality (or against an aggregation of indicators) to determine whether to use slot aggregation for uplink transmissions, such as uplink transmissions 108. The activation threshold can vary based on UE location within the cell 106 or based on the band used for the uplink transmissions. In some circumstances, the activation threshold can vary over time, updated based on machine learning, on configuration updates from a network operator, or both. The performance indicators too may vary. One example group of performance indicators may include any one or more of jitter, MOS, a count of NACKs received, BLER, packet delay, muting, or round-trip times. Other examples may include RSRP or noise RSRQ. The UE 102 may measure the performance indicators and compare them to the activation threshold periodically or on an event-driven basis. For example, the comparison may be triggered anytime the UE 102 has uplink packets to transmit (such packets could be either voice or data).

Upon determining that the performance indicator(s) meet the activation threshold for slot aggregation, the UE 102 may determine whether to use pre-scheduled or configured grants or to request slot aggregation from the base station 104 in a scheduling request. Using either those grants or based on slots 118 indicated in a response to the scheduling request, the UE 102 may provide packets 110 and 112 to a radio interface of the UE 102 for transmission using the slots 118.

In various implementations, the slots 118 may belong to a single subframe and may comprise consecutive slots. (Slots 114, which are doing being used for slot aggregation may be adjacent, as shown, or non-adjacent, within a same or different subframe.) While FIG. 1 shows each of first packet 110 and second packet 112 being repeated once, each in two consecutive slots 118 as a result of slot aggregation, groupings of four or eight slots can instead be used (e.g., for additional repetitions). Further, adjacent slots across multiple consecutive subframes may also be aggregated using slot aggregation in order to repeat transmission of packets (such as, e.g., first packet 110 and second packet 112). Also, while FIG. 1 shows one packet per slot 114/118, it is to be understood that a packet may use multiple consecutive slots 114/18 (e.g., first packet 110 could use two consecutive slots 118, and repeating first packet 110 once could involve four consecutive slots 118).

The UE 102 continues to send packets for uplink transmission (voice, data, or both) until a deactivation threshold is met. Such a deactivation threshold may have a hysteresis gap with the activation threshold to prevent ping-ponging in and out of slot aggregation mode. Also, the deactivation threshold may be compared against the same performance indicators as the activation threshold, against an entirely different one or more performance indicators, or against an overlapping set (some of the same performance indicators, some different performance indicators). The deactivation threshold may also be generated and updated based on machine learning, network operator updates, or both.

In addition to uplink quality, the UE 102 may also consider its location within the cell 106. Coverage may be stronger at the cell center 106a than at the cell edge 106b, so it may be more important for the UE 102 to use slot aggregation when at the cell edge 106b. In such examples, the activation threshold may vary based on location (e.g., a more easily triggered activation threshold at the cell edge 106b than at the cell center 106a).

In further implementations, the UE 102 may also consider the band it is using for uplink transmissions 108. For example, if the UE 102 is on a band where it is more spectrally efficient, it may be desirable to avoid handover to a different band. Slot aggregation may improve some performance indicators for uplink quality, and if those are used for handover (and triggered before handover would be triggered), handover may be avoided and the UE 102 may stay on its band. In some examples, the activation threshold may be varied based on band to increase the likelihood of slot aggregation with some bands or to decrease it with others (e.g., a band where the UE 102 is less spectrally efficient).

In various implementations, the base station 104 may determine that one or more performance indicators for the uplink transmissions 108 from the UE 102 meet an activation threshold for slot aggregation. The base station 104 may perform this determining instead of the UE 102 or in addition to it. The activation threshold used, in some implementations, may be met before a handover threshold is met to ensure that slot aggregation is utilized. The base station 104 may make pre-scheduled or configured grants of slots 118 to enable the UE 102 to transmit packets 110 and 112, may respond to a request for slot aggregation from the UE 102, or both. If both the base station 104 and UE 102 independently determine that the activation threshold is met, no sending of an indication to the UE 102 may be needed. But regardless, the base station 104 may send an indication to UE 102 that the UE 102 should perform slot aggregation, and such an indication may include a specification of which slots 118 are used.

The performance indicator(s) used by the base station 104 may be the same as the performance indicator(s) used by the UE 102, different, or overlapping. For example, the base station 104 may utilize SINR and power headroom for activation threshold comparisons. Further, like the UE 102, the base station 104 may also apply a deactivation threshold and, if that threshold is met, may provide a further indication or instruction to the UE 102 to cause the UE 102 to stop performing slot aggregation.

In some implementations, upon receiving uplink transmissions 108 sent using slot aggregation, the base station 104 may remove any redundant packets from the uplink transmission before retransmitting, e.g., to a core network. For example, if one of the redundant copies of first packet 110 is not received, there is no redundant packet and the received first packet 110 is retransmitted. If both copies of the second packet 112 are received, the base station 104 can determine that there is s redundant copy (e.g., using cyclic redundancy checks) and transmit only one of the redundant copies (e.g., the first received copy).

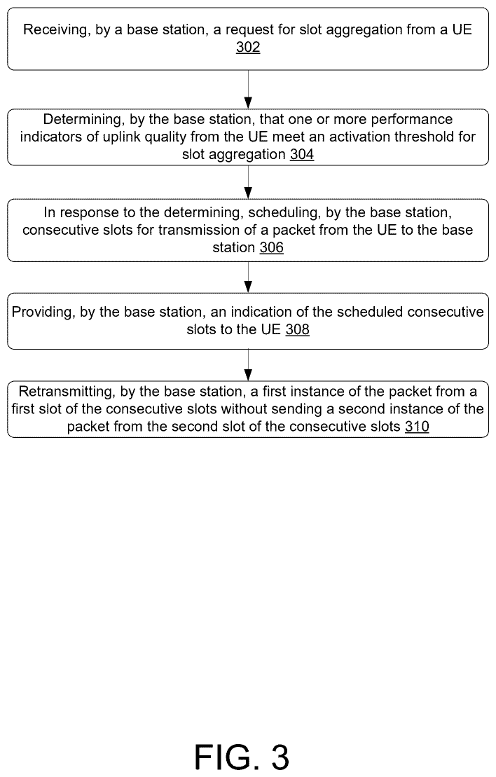

FIGS. 2-3 illustrate example processes. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 2 is a flow diagram of an illustrative process implemented by a UE for determining that performance indicator(s) of uplink quality meet an activation threshold for slot aggregation and, in response, transmitting a packet repeatedly to a base station in consecutive slots. As illustrated at 202, a UE determines that one or more performance indicators of uplink quality meet an activation threshold for slot aggregation. The determining may further be based on a location of the UE within a cell associated with the base station, and the activation threshold may vary based on the location of the UE within the cell. In some implementations, the one or more performance indicators may include at least one of jitter, a mean opinion score (MOS), a number of negative acknowledgements (NACKs) received, BLER, packet delay, muting, or round-trip times. Also or instead, the one or more performance indicators may include at least one of a reference signal received power (RSRP) or a noise reference signal received quality (RSRQ) and the activation threshold may be reached before a handover threshold for handing over a connection between the UE and the base station from a first band to a second band. Additionally, the activation threshold may vary based on which band the UE is using.

At 204, response to the determining, the UE may request slot aggregation in a scheduling request to the base station.

At 206, in response to the determining, the UE transmits a packet repeatedly to a base station in consecutive slots. At 208, the transmitting may include using pre-scheduled grants or configured grants to transmit the packet repeatedly in the consecutive slots. Such pre-scheduled grants or configured grants may be used, for example, when the UE has not requested slot aggregation from the base station.

At 210, the UE may repeatedly perform the transmitting until a second one or more performance indicators meet a deactivation threshold. In some implementations, there may be a hysteresis gap between the activation threshold and the deactivation threshold. Also, in further implementations, the one or more performance indicators may be first one or more performance indicators, and the first one or more performance indicators may at least partially overlap with the second one or more performance indicators.

FIG. 3 is a flow diagram of an illustrative process implemented by a base station for determining that performance indicator(s) of uplink quality from a UE meet an activation threshold for slot aggregation and, in response, scheduling consecutive slots for transmission of a packet from the UE to the base station. As illustrated at 302, a base station may receive a request for slot aggregation from a UE.

At 304, the base station determines that one or more performance indicators of uplink quality from the UE meet an activation threshold for slot aggregation. The activation threshold may be reached before a handover threshold for handing over a connection between the UE and the base station from a first band to a second band. Further, the one or more performance indicators include at least one of uplink signal-to-noise-ratio (SINR) or power headroom.

At 306, in response to the determining, the base station schedules consecutive slots for transmission of a packet from the UE to the base station.

At 308, the base station may provide an indication of the scheduled consecutive slots to the UE.

At 310, upon receiving transmission of the packet from the UE, the base station may retransmit a first instance of the packet from a first slot of the consecutive slots without sending a second instance of the packet from the second slot of the consecutive slots.

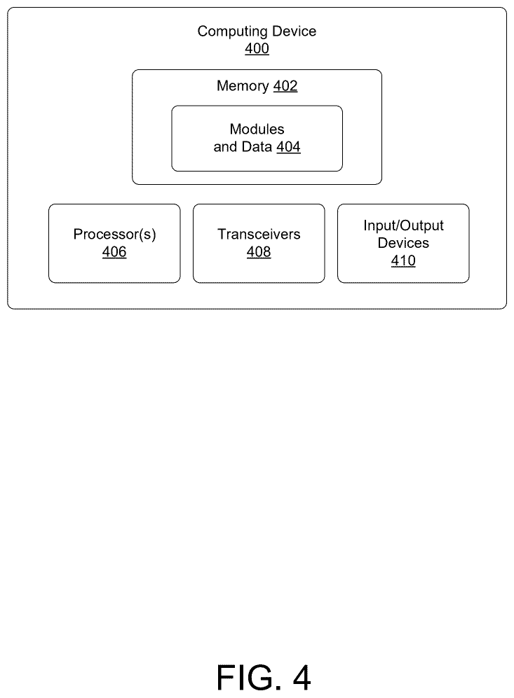

FIG. 4 is a schematic diagram of a computing device capable of implementing functionality of at least one of the UE and base station described herein. As shown, the computing device 400 includes a memory 402 storing modules and data 404, processor(s) 406, transceivers 408, and input/output devices 410.

In various examples, the memory 402 can include system memory, which may be volatile (such as RAM), non-volatile (such as ROM, flash memory, etc.) or some combination of the two. The memory 402 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 402 can include one or more software or firmware elements, such as computer-readable instructions that are executable by the one or more processors 406. For example, the memory 402 can store computer-executable instructions associated with modules and data 404. The modules and data 404 can include a platform, operating system, and applications, and data utilized by the platform, operating system, and applications. Further, the modules and data 404 can implement any of the functionality for the UE 102, base station 104, or any other node/device described and illustrated herein.

In various examples, the processor(s) 406 can be a central processing unit (CPU), a graphics processing unit (GPU), or both CPU and GPU, or any other type of processing unit. Each of the one or more processor(s) 406 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 406 may also be responsible for executing all computer applications stored in the memory 402, which can be associated with types of volatile (RAM) and/or nonvolatile (ROM) memory.

The transceivers 408 can include modems, interfaces, antennas, Ethernet ports, cable interface components, and/or other components that perform or assist in exchanging wireless communications, wired communications, or both.

While the computing device need not include input/output devices 410, in some implementations it may include one, some, or all of these. For example, the input/output devices 410 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 410 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 410 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

What is claimed is:

1. A method comprising:
determining, by a user equipment (UE), that one or more performance indicators of uplink quality meet an activation threshold for slot aggregation; and
in response, transmitting, by the UE, a packet repeatedly to a base station in consecutive slots.

2. The method of claim 1, wherein the determining is further based on a location of the UE within a cell associated with the base station.

3. The method of claim 2, wherein the activation threshold varies based on the location of the UE within the cell.

4. The method of claim 1, wherein the one or more performance indicators include at least one of jitter, a mean opinion score (MOS), a number of negative acknowledgements (NACKs) received, block error rate (BLER), packet delay, muting, or round-trip times.

5. The method of claim 1, wherein the transmitting comprises using pre-scheduled grants or configured grants to transmit the packet repeatedly in the consecutive slots.

6. The method of claim 1, further comprising, in response to the determining, requesting slot aggregation in a scheduling request to the base station.

7. The method of claim 1, further comprising repeatedly performing the transmitting until a second one or more performance indicators meet a deactivation threshold.

8. The method of claim 7, wherein there is a hysteresis gap between the activation threshold and the deactivation threshold.

9. The method of claim 7, wherein the one or more performance indicators are first one or more performance indicators, and the first one or more performance indicators at least partially overlap with the second one or more performance indicators.

10. The method of claim 1, wherein the one or more performance indicators include at least one of a reference signal received power (RSRP) or a noise reference signal received quality (RSRQ) and the activation threshold is reached before a handover threshold for handing over a connection between the UE and the base station from a first band to a second band.

11. The method of claim 10, wherein the activation threshold varies based on which band the UE is using.

12. A base station comprising:
one or more processors; and
programming instructions configured to be operated by the one or more processors to perform operations including:
determining that one or more performance indicators of uplink quality from a user equipment (UE) meet an activation threshold for slot aggregation; and
in response to the determining, scheduling consecutive slots for transmission of a packet from the UE to the base station.

13. The base station of claim 12, wherein the operations further include providing an indication of the scheduled consecutive slots to the UE.

14. The base station of claim 12, wherein the operations further include receiving a request for slot aggregation from the UE.

15. The base station of claim 12, wherein the activation threshold is reached before a handover threshold for handing over a connection between the UE and the base station from a first band to a second band.

16. The base station of claim 12, wherein the one or more performance indicators include at least one of uplink signal-to-noise-ratio (SINR) or power headroom.

17. The base station of claim 12, wherein the operations further include retransmitting a first instance of the packet from a first slot of the consecutive slots without sending a second instance of the packet from a second slot of the consecutive slots.

18. A non-transitory computer storage medium having stored thereon programming instructions that, when executed by one or more processors of a user equipment (UE), cause the UE to perform operations comprising:
determining that one or more performance indicators of uplink quality meet an activation threshold for slot aggregation; and
in response, transmitting a packet repeatedly to a base station in consecutive slots.

19. The non-transitory computer storage medium of claim 18, wherein the one or more performance indicators include at least one of jitter, a mean opinion score (MOS), a count of negative acknowledgements (NACKs) received, block error rate (BLER), packet delay, muting, or round-trip times.

20. The non-transitory computer storage medium of claim 18, wherein the transmitting comprises using pre-scheduled grants or configured grants to transmit the packet repeatedly in the consecutive slots.
